(19) United States
(12) Patent Application Publication
(10) Pub. No.: US 2005/0110354 A1
(43) Pub. Date: May 26, 2005

(54) Unsealed non-corroding wet washdown motor

(75) Inventor: Susanta Datta, Londonderry, NH (US)

Correspondence Address: WALL MARJAMA & BILINSKI, 101 SOUTH SALINA STREET, SUITE 400, SYRACUSE, NY, 13202, US

(73) Assignee: Cleveland Motion Controls, Inc., Cleveland, OH (US)

(21) Appl. No.: 10/719,768

(22) Filed: Nov. 21, 2003

(51) Int. Cl. D06F 33/00; H02K 5/12

(52) U.S. Cl. 310/88; 68/147; 68/12.16; 310/89

(57) ABSTRACT

The invention relates to motors and motor assemblies that can be washed without causing corrosion of components, and without causing premature motor failure as a result of corrosion. The motor and motor assembly comprise components constructed from non-corroding materials, such as stainless steel. The motor and motor assembly are constructed according to an unsealed design, in which washing fluid can enter the motor and the motor housing during washing. The washing fluid can drain away after washing is completed. The unsealed design permits heat generated during operation of the motor to drive off residual washing fluid. The motor and motor assembly can be readily cleaned, easily can be maintained in an corrosion-free state, and are not subject to premature failure from corrosion induced by trapped washing fluid.

### CROSS-REFERENCE TO RELATED APPLICATION

This application is related to an application entitled, “STAINLESS STEEL UNSEALED MOTOR,” identified further by Attorney Docket No. 847-072, and subject to assignment to the same assignee, which application is being filed on even date herewith.

### FIELD OF THE INVENTION

The invention relates to electric motors used in food or medicine preparation in general and particularly to an electric motor that employs washable non-corroding components.

### BACKGROUND OF THE INVENTION

Motor assemblies used in the food preparation or medicine preparation fields are required to be compatible with FDA regulations. In particular, the FDA has promulgated regulations regarding the absence of corrosion on surfaces that may come into contact with materials such as food and medicines that are undergoing processing. The absence of corrosion requirement has been met using two approaches. In one approach, a fully sealed motor is protected from corrosion by the use of surface preparations such as FDA approved paints. In another approach, the use of a fully sealed motor involves providing a housing made from a non-corroding material such as stainless steel. The surfaces of the motor assembly must be able to undergo cleansing, for example by being washed with solutions that clean and/or disinfect the surfaces of the motor assembly.

The surface of the motor assembly is required to be free of oxidation. During use, the surface of the motor assembly may be subject to mechanical impacts and chemical stresses, such as are possible when materials are mixed or stirred, during such times when substances are added into volumes being mixed, or when materials are removed from mixing or processing containers. In some cases, impacts with other objects may occur by accident.

A number of problems in the use of such washable motor assemblies have been observed. In use, the paint on the surface of painted motor assembly often suffers chipping. The chips in the paint permit the surface of the motor assembly to corrode. In addition, the seals used to seal the motor assembly often are subject to degradation. When the seals fail, water or other cleaning fluid enters the housing and becomes trapped inside the housing. Thermal cycling can cause condensation to form on various parts of the motor. The trapped moisture causes deterioration of the motor winding, which leads to premature motor failure. Such problems result in shortened operational life, and may cause difficulties with regard to maintaining operations in conformity with FDA regulation or oversight.

There is a need for motors and motor assemblies for use in food or medicine preparation applications that are more resistant to corrosion and that are not subject to premature failure.

### SUMMARY OF THE INVENTION

In one aspect, the invention relates to a washable electric motor assembly for use in food or medicine preparation applications subject to FDA oversight. The washable electric motor assembly comprises an electric motor having a component with a non-corroding exposed surface; and an unsealed housing comprising a non-corroding housing material, the unsealed housing configured to admit washing fluid during a washing operation and to allow the exit of the washing fluid upon completion of the washing operation. The washable electric motor assembly is resistant to the effects of corrosive substances, and the electric motor is protected against failure from corrosion by the exiting of the washing fluid from the unsealed housing.

In one embodiment, the unsealed housing is further configured to permit the washing fluid to be driven off by thermal energy generated by operation of the electric motor. In one embodiment, a selected one of an electric motor having a component with a non-corroding exposed surface and a non-corroding housing material comprises titanium. In one embodiment, the non-corroding housing material comprises a base metal covered with a selected one of electroless nickel plating and cobalt coating. In one embodiment, the electric motor is a permanent magnet brushless motor. In one embodiment, a component of the motor comprises a coating of a vapor deposited material that can form a pinhole free protective film. In one embodiment, the vapor deposited material is parylene.

In one embodiment, the washable electric motor assembly further comprises an encoder. In one embodiment, the washable electric motor assembly further comprises a resolver.

In another aspect, the invention features a method of washing an unsealed electric motor assembly. The motor assembly includes an unsealed non-corroding housing material and a motor having non-corroding components. The motor assembly is configured to be used in food or medicine preparation activities subject to FDA oversight. The method comprises the steps of washing the unsealed electric motor assembly with a washing fluid, whereby the washing fluid is permitted to enter the interior of the unsealed electric motor assembly; removing the washing fluid from the unsealed electric motor assembly; and operating the electric motor, whereby residual washing fluid remaining within the unsealed electric motor assembly is driven off as a result of the heating of the motor during the operation. The electric motor and the electric motor assembly are cleaned, and the electric motor is protected against failure from corrosion by the driving off of the residual fluid from the unsealed electric motor assembly.

In one embodiment, the step of removing the washing fluid from the unsealed washable electric motor assembly includes permitting the washing fluid to drain from the unsealed washable electric motor assembly.

In one embodiment, the method further comprises the step of removing the unsealed electric motor assembly from an apparatus to which it is mounted prior to performing the washing step.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a cross sectional engineering drawing of a first embodiment of a motor and a motor assembly including a motor, a motor housing and a resolver, according to principles of the invention;

FIG. 2A is a schematic drawing of windings in a stator of a three-phase, eight-pole motor for use in motors that embody principles of the invention;

FIG. 2B is a schematic drawing showing a connection diagram for the wiring in a resolver for use in motors that embody principles of the invention;

FIG. 2C is a diagram showing the relative angular relations among waveforms observed from pairs of motor windings and across terminals of the resolver in motors that embody principles of the invention;

FIG. 3 is a cross sectional engineering drawing of a second embodiment of a motor and a motor assembly including a motor, a motor housing and an encoder, according to principles of the invention;

FIG. 4 is a diagram showing the relative angular relations among waveforms observed from pairs of motor windings and across terminals of the encoder in motors that embody principles of the invention;

FIG. 5 is a depiction of an embodiment of a rotor with protected stainless steel sleeve shrunk over two stainless steel plates, according to principles of the invention;

FIG. 6 is a depiction showing the disassembled mechanical components of a motor having a resolver, according to principles of the invention;

FIG. 7 is a depiction showing the disassembled electromagnetic components of a motor having a resolver, according to principles of the invention;

FIG. 8 is a depiction of an assembled motor having a resolver, according to principles of the invention;

FIG. 9 is a depiction of an embodiment of a stator and a resolver with conformal coating, according to principles of the invention; and

FIG. 10 is a depiction of an embodiment of a rotor with conformal coating, according to principles of the invention.

### DETAILED DESCRIPTION OF THE INVENTION

The invention solves the problems of corrosion of the motor housing and premature failure of the motor itself by using non-corroding substances as the materials of construction of the various components, and by allowing the washing fluid to enter and to exit the motor assembly, i.e., an unsealed assembly is provided.

In the electric motor arts, motors having different capacities may be used for various applications. The principles of the invention are applicable to motors without regard to the exact size and capacity of a motor. Table I lists a variety of motor sizes and capacities, as approximate relationships. Those familiar with the electric motor arts will understand that motors of larger or smaller size and capacity can also embody the principles of the invention.

TABLE I

| Diameter (inches) | Length (inches) | Horsepower |
|---|---|---|
| 2.25 | 12 | 1.5 |
| 3.5 | 11.75 | 2.5 |
| 4.25 | 15.25 | 4.5 |

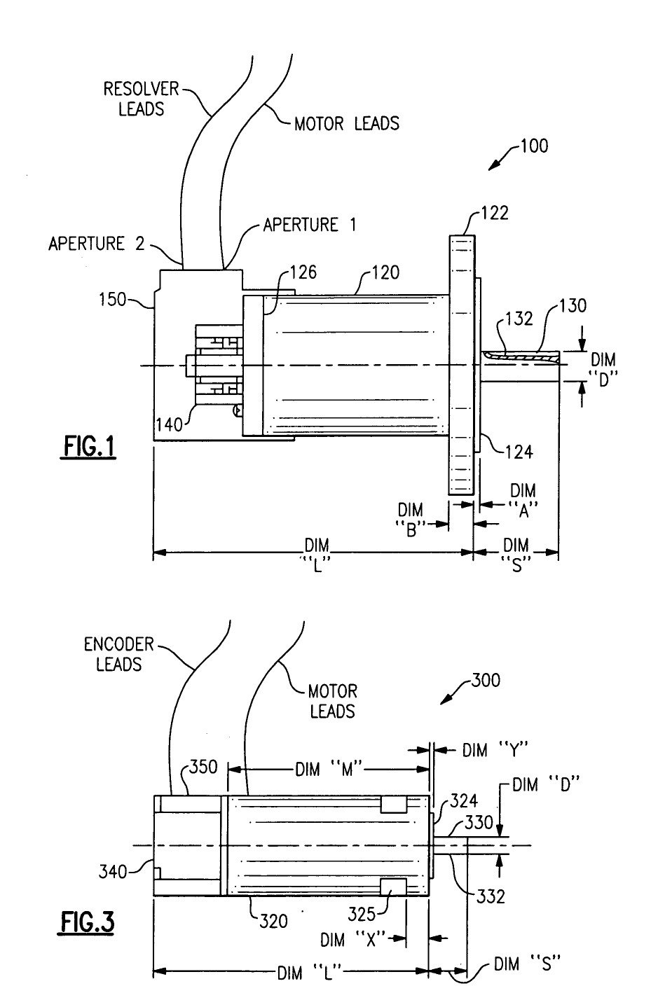

FIG. 1 is a cross sectional engineering drawing of a first embodiment of a motor and motor assembly including a motor, a motor housing, and a resolver. FIG. 1 shows a motor and motor assembly 100, having a motor housing 120, an output shaft 130, and a resolver 140 internal to a resolver housing 150. The motor and motor assembly 100 is unsealed and designed to operate in a wet environment. The motor comprises an unsealed stator designed to operate in a wet environment.

The motor is not shown in FIG. 1. In one embodiment, the motor is based on a conventional three phase eight-pole permanent magnet (PM) motor design. The number of poles is not critical and can be varied while remaining within the scope of the invention. As one example, in a second embodiment a four pole motor can be used in place of an eight pole motor. In one embodiment, the rotor magnet assembly is sealed within a stainless steel sleeve that makes contact with a stainless steel end plate disposed at each end of the rotor magnet assembly, effectively sealing the rotor magnet assembly within a stainless steel “can” or chamber. The motor can comprise a rotor constructed in a single piece design, having a stainless steel sleeve configured to match the outside diameter of a permanent magnet that results in a watertight construction of the rotor. The motor is optionally protected by a thermostatic overheating sensor. In other embodiments, other materials can be used in place of the stainless steel “can,” as will be described in greater detail below.

The motor housing 120, and an optional mounting plate 122, if required, is constructed in a single piece design. In other embodiments, the design is a conventional design having a housing and a front end cap. The motor housing is unsealed to allow the entry of washing fluid during a washing operation, and to permit the washing fluid to exit after completion of the washing operation. A preferred material of construction is 300 series stainless steel. A rear end cap 126 is preferably made from 300 series stainless steel.

In other embodiments, the motor housing 120, mounting plate 122 and rear end cap 126 (or alternatively, motor housing, front end cap, rear end cap and optional mounting plate) are constructed from other non-corroding materials, such as titanium, monel, and other well-known metals and alloys that resist corrosion. In other embodiments, the motor housing and caps, as well as the mounting plate, are constructed from base metal (e.g., brass, aluminum, or other metal subject to corrosion) which structure is then plated or overcoated with non-corroding metal such as electroless nickel plating, or cobalt coating. While still other non-corroding materials are available and may be used, one issue that should be addressed in the selection of the non-corroding material is thermal transfer of heat built up in the motor during operation. A non-corroding material that is thermally insulating could create the problem of excessive heat build-up in the motor during operation. The non-corroding properties of 300 series stainless steel, the thermal transfer characteristics of such steel, and the cost of such steel make it a good choice for use in the environments contemplated.

In other embodiments, a motor winding, a lamination stack that holds the winding, a rotor-magnet assembly and a resolver or a stator/rotor are, protected with a FDA approved operationally acceptable coating material. The material selected preferably has high electrical insulation properties, superior chemical resistance and provides a conformal coating that is free of pin holes. In one embodiment, an organic material is used. One such material is Parylene grades N, C or D having varying properties. Parylene is manufactured by Cookson Electronics (see www.scscookson.com) and is available from Specialty Coating Systems, of 7645 Woodland Drive, Indianapolis, Ind. 46278.

Parylene is a vapor deposited material that can form a pinhole free protective film. Parylene has been found to provide conformal and bio-compatible films. Parylene is inert and protects against moisture, chemicals, and electrical charge, thereby satisfying the requirements set forth above. Parylene is commonly used in many industries, including the coating of medical devices ranging from silicone tubes to advanced coronary stents. Parylene is a material that has been approved for use in various applications requiring FDA oversight. Parylene dimer material and equipment used for its deposition are commercially available, for example from Specialty Coating Systems of 7645 Woodland Drive, Indianapolis, Ind. 46278.

In some embodiments, yet another rotor construction may be contemplated: In place of Parylene conformal coating, the rotor may be protected either by a heat shrinkable Teflon or stainless steel sleeve shrunk on the magnets between the two stainless steel end plates to form a water tight path.

The motor further comprises bearings. The bearings are sealed type bearings that comprise lubricants compatible with FDA regulation or oversight. One type of FDA-approved lubricant is ThermaPlex FoodLube Bearing Grade Grease provided by LPS Laboratories of 4647 Hugh Howell Road, Tucker, Ga. For example, the bearings are constructed of 316 stainless steel or 440 stainless steel races, shields, and seals. All mounting hardware for the motor and motor housing, such as shims, screws, washers, and the like, are constructed of non-oxidizing materials compatible with FDA regulations.

The motor in the first embodiment includes a resolver 140. The resolver 230 is an unsealed resolver that is enclosed in a stainless steel cover. For example, a suitable resolver is a model 15BRCX available from Danaher Linear Motion Systems of 45 Hazelwood Drive, Amherst, N.Y. 14228. In one embodiment, a resolver that has sufficient resolution and an accuracy of plus or minus 7 arc minutes is used.

The motor is powered and the resolver 140 provides a signal by wiring that is covered with insulation of a type acceptable under applicable FDA regulation or oversight. As shown in FIG. 1, the wires providing power to the motor, identified as “motor leads,” pass through an aperture (aperture 1) in the motor housing and assembly 100. The wires carrying the resolver signals as denoted as “resolver leads” and similarly pass through an aperture (aperture 2) in the motor housing and assembly 100. In one embodiment, Teflon® fluoropolymer material is suitable insulation for wiring for the motor, wiring for resolvers, wiring for encoders, and wiring for Hall sensors. Teflon® is a trademark of E.I. DuPont de Nemours & Co. The features and operation of the first kind of motor described above that provide reduced corrosion and prevent premature motor failure are present in this embodiment as well.

A number of dimensions are indicated in FIG. 1 in schematic format. An overall length of the motor assembly measured from the front mounting surface is denoted as DIM “L.” A shaft diameter is denoted as DIM “D.” The shaft 130 is indicated as having a fiduciary for angular location 132 of an object on the shaft, such as a keyway, a mechanical flat, a spline, an indentation, or the like, so that an object mounted on the shaft can be maintained in a known angular orientation with regard to the shaft. The optional mounting plate 122 has a thickness denoted as DIM “B.” An undercut on the front surface of the optional mounting plate 122 of depth identified as DIM “A” can be provided, thereby creating a raised indexing surface 124 that is useful in locating the motor assembly for installation in and attachment to a piece of machinery.

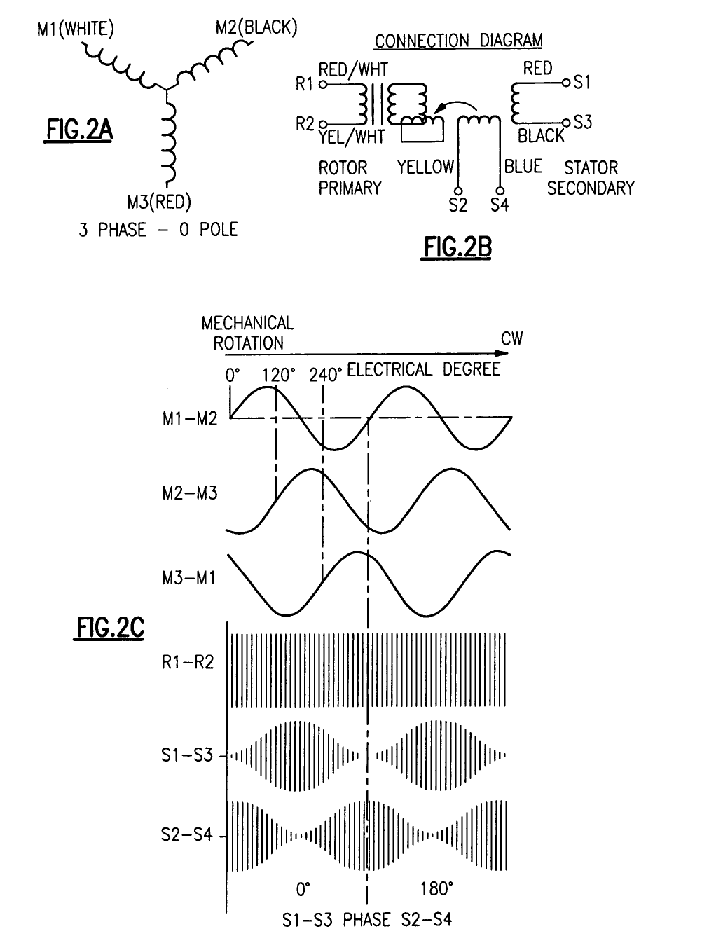

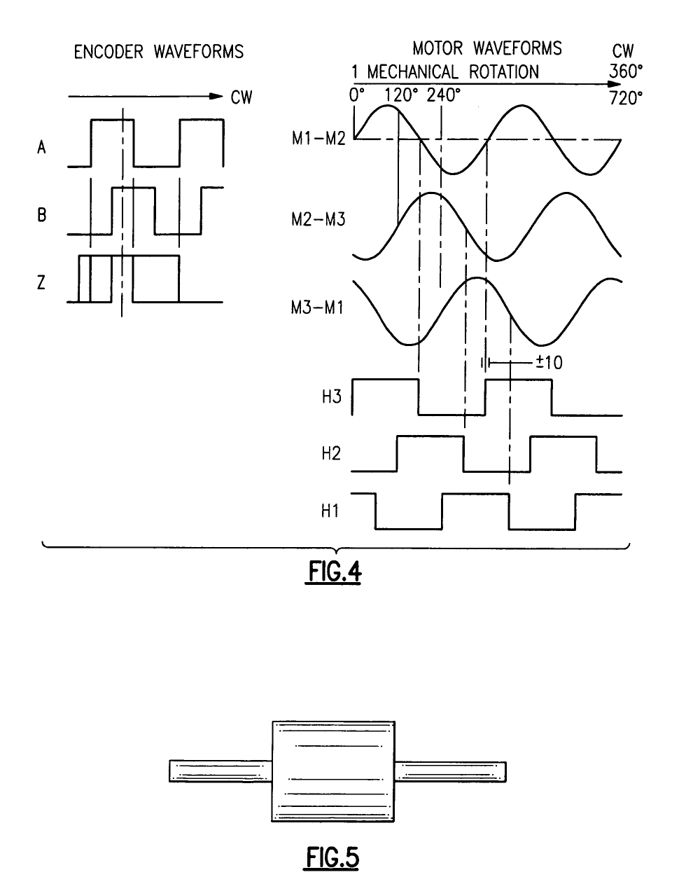

FIG. 2A is a schematic drawing of windings in a stator of a three-phase, eight-pole motor for use in motors that embody principles of the invention. The windings connected in a “star” or “Y” configuration, and are identified by their terminals; terminal M1 (which in one embodiment is identified by a white connection wire), terminal M2 (which in one embodiment is identified by a black connection wire), and terminal M3 (which in one embodiment is identified by a red connection wire). As is well understood in the electrical arts, the center node is maintained at ground potential in a three phase system. As is also well understood by those of skill in the electrical arts, it is possible to connect a three phase system in a “delta” configuration, under proper mathematically specified transformations as compared to a “Y” configuration.

FIG. 2B is a schematic drawing showing a connection diagram for the wiring in a resolver for use in motors that embody principles of the invention. The resolver involves electromagnetic coupling, which is denoted by the symbol for a transformer in FIG. 2B. The rotor spins with the shaft of the motor and produces pulses as shown in FIG. 2C. The secondary windings, being oriented at 90 degrees to each other, produce sinusoidally varying output as a function of the angle of the shaft, with the two output signals being mathematically orthogonal to each other (e.g. in a sine-cosine relationship).

FIG. 2C is a diagram showing the relative angular relations among waveforms observed from pairs of motor windings and across terminals of the resolver in motors that embody principles of the invention, when the motor rotates in a clockwise direction, as viewed from the motor shaft. The curves M1-M2, M2-M3, and M3-M1 are the signals cross pairs of motor winding contacts. The signal R1-R2 is the signal from the rotor of the resolver, and the signals S1-S3 and S2-S4 are the signals from the stator secondary windings of the resolver.

FIG. 3 is a cross sectional engineering drawing of a second embodiment of a motor and a motor assembly 300 including a motor, a motor housing and an encoder. FIG. 3 shows a motor housing 320 and an encoder 340. The motor, which is not shown in the cross sectional diagram, is unsealed and designed to operate in a wet environment. The motor is optionally protected by a thermostatic overheating sensor. The motor comprises an unsealed stator designed to operate in a wet environment. The motor also comprises a rotor constructed in a single piece design, having a stainless steel sleeve configured to match the outside diameter of a permanent magnet (“PM”) assembly and a stainless steel end plate disposed at each end of the PM assembly that results in a watertight construction of the rotor. In other embodiments, a motor winding, a lamination stack that holds the winding, a rotor-magnet assembly and an encoder having a stator and a rotor are protected with a FDA approved operationally acceptable coating material, such as parylene.

In one embodiment, the motor housing 320, and an optional mounting plate, if required, is constructed in a single piece design. Alternatively, a housing, a front end cap and a rear end cap are used, as described above. The motor housing is unsealed to allow the entry of washing fluid during a washing operation, and to permit the washing fluid to exit after completion of the washing operation. A preferred material of construction is 300 series stainless steel. A rear end cap is preferably made from 300 series stainless steel. In other embodiments, the motor housing, mounting plate and rear end cap (or alternatively, motor housing, front end cap, rear end cap and optional mounting plate) are constructed from other non-corroding materials, such as titanium, monel, and other well-known metals and alloys that resist corrosion. In other embodiments, the motor housing and caps, as well as the mounting plate, are constructed from base metal (e.g., brass, aluminum, or other metal subject to corrosion) which structure is then plated or overcoated with non-corroding metal such as electroless nickel plating, or cobalt coating. While still other non-corroding materials are available and may be used, one issue that should be addressed in the selection of the non-corroding material is thermal transfer of heat built up in the motor during operation. A non-corroding material that is thermally insulating could create the problem of excessive heat build-up in the motor during operation. The non-corroding properties of 300 series stainless steel, the thermal transfer characteristics of such steel, and the cost of such steel make it a good choice for use in the environments contemplated.

The motor further comprises bearings. The bearings are sealed type bearings that comprise lubricants compatible with FDA regulation or oversight. One type of FDA-approved lubricant is ThermaPlex FoodLube Bearing Grade Grease provided by LPS Laboratories of 4647 Hugh Howell Road, Tucker, Ga. For example, the bearings are constructed of 316 stainless steel or 440 stainless steel races, shields, and seals. All mounting hardware for the motor and motor housing 100, such as shims, screws, washers, and the like, are constructed of non-oxidizing materials compatible with FDA regulation or oversight.

The motor and motor housing 300 in the second embodiment includes an encoder 340. The encoder 340 is not operable under wet conditions and therefore is retained in a sealed compartment. The encoder 340 is a commutating encoder that is enclosed in a sealed stainless steel cover. For example, a suitable encoder is a model HS15 encoder available from Cleveland Motion Controls of Billerica, Mass. The HS15 commutating (or non-commutating) encoders are available with up to 5000 points per revolution (PPR). Optionally, an encoder in conjunction with a Hall sensor commutation may be used instead of the commutating encoder. In yet other embodiments, motors can also be built with Hall sensor commutation only.

The motor is powered and the encoder 340 provides a signal by wiring that is covered with insulation of a type acceptable under applicable FDA regulation or oversight. In one embodiment, Teflon® fluoropolymer material is suitable insulation for wiring for the motor, wiring for resolvers, wiring for encoders, and wiring for Hall sensors.

FIG. 3 depicts the wires providing power to the motor, identified as “motor leads.” The motor leads pass through an aperture in the motor housing and assembly 300. The aperture that allows entry of the motor leads need not be sealed against moisture, because the motor housing 320 is not sealed against moisture. The wires carrying the encoder signals as denoted as “encoder leads” and similarly pass through an aperture in the encoder housing 350. Since the encoder cannot tolerate moisture, the aperture in the encoder housing 350 through which the encoder leads pass is sealed with a suitable FDA approved sealant, for example as a pressure seal. Teflon® is a suitable insulating material for encoder lead wiring. The features and operation of the first kind of motor described above that provide reduced corrosion and prevent premature motor failure are present in this embodiment as well.

A number of dimensions are indicated in FIG. 3 in schematic format. An overall length of the motor assembly measured from the front mounting surface is denoted as DIM “L.” A length of the motor housing 320 is denoted as DIM “M.” A shaft diameter is denoted as DIM “D.” The shaft 330 is indicated as having a fiduciary for angular location 332 of an object on the shaft, such as a keyway, a mechanical flat, a spline, an indentation, or the like, so that an object mounted on the shaft can be maintained in a known angular orientation with regard to the shaft. An undercut on the front surface of the motor housing 320 of depth identified as DIM “Y” can be provided. A motor nameplate 325, that provides information about the motor, is situated a distance denoted as DIM “X” from the mounting surface of the motor housing 320.

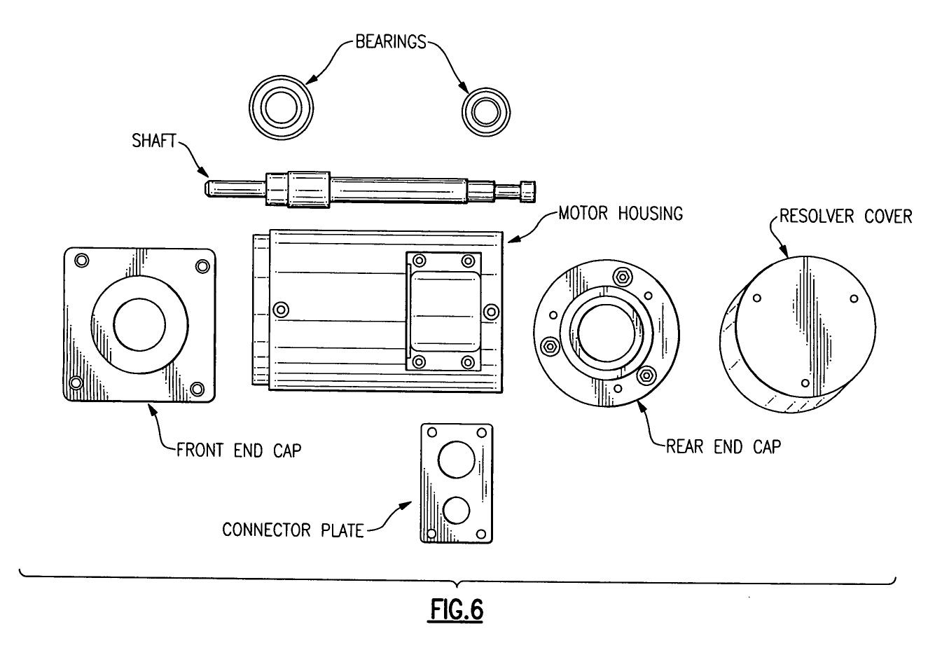

FIG. 4 is a diagram showing the relative angular relations among waveforms observed from pairs of motor windings and across terminals of the encoder in motors that embody principles of the invention. The waveforms shown are observed when a motor rotates in a clockwise direction as viewed from the motor shaft. The sinusoidal signals represent the waveforms of voltage appearing across pairs of motor winding terminals. The square wave signals denoted H1, H2 and H3 are Hall sensor signals. The Hall sensor signals are used to commutate the motor windings. The encoder waveforms denoted by A, B, and Z, provide signals to control equipment that senses the direction in which the motor system is turning. The motor control equipment also uses the signals to determine a line count, which is equated to a position or velocity of the system.

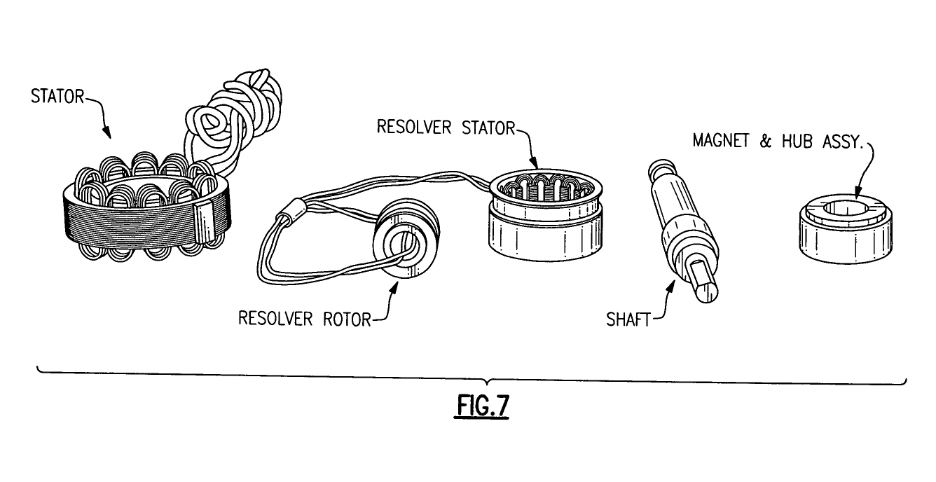

FIG. 5 is a depiction of an embodiment of a rotor protected with a stainless steel sleeve shrunk over two stainless steel plates, according to principles of the invention. This is an example of the stainless steel “can” construction described hereinabove.

Methods of construction of an exemplary motor embodying the invention are now presented with accompanying Figures.

FIG. 6 is a depiction showing the disassembled mechanical components of a motor having a resolver, according to principles of the invention. In FIG. 6 there are shown examples of components used in constructing one embodiment of the invention, comprising a motor and a resolver. In the center of FIG. 6 is a depiction of a motor housing. The motor housing has defined therein a number of apertures.

In FIG. 6, a substantially square front end cap is shown to the left of the motor housing. The front end cap is assembled to the left end of the motor housing and attached thereto with screws using the holes defined at the left end of the motor housing, such as the hole on the top surface of the motor housing at the left end as depicted, and the hole visible lower down on the outer curved surface of the motor housing at the left end thereof, the screws passing through the holes and entering the front end cap in tapped blind holes provided on the back side thereof, and not visible in FIG. 6. Alternatively, mounting brackets that connect the motor housing and the front end cap can be used. The front end cap also has a central aperture that is designed to accommodate a bearing, such as the left bearing shown at the top of FIG. 6. The front end cap also is shown having four holes, one in substantially each corner extremity of the front end cap, for use in bolting the assembled motor assembly to other machinery. The front end cap also is shown with a raised annular portion on the exposed surface thereof, corresponding to indexing surface 124 of FIG. 1.

In FIG. 6 there is to the right of the motor housing a rear end cap. The rear end cap is circular with a central aperture that is designed to accommodate a bearing, such as the right bearing shown at the top of FIG. 6. The rear end cap is attached to the motor housing with screws, in a fashion similar to the attachment of the front end cap. Holes at the right end of the motor housing are provided for attaching the rear end cap. The rear end cap has defined therein a small circular aperture (the resolver lead access opening) for passage of resolver lead wires from a resolver into the motor housing, which circular aperture is shown in FIG. 6 at a position close to the “three o'clock” position, considering the rear end cap as a clock face. The rear end cap also has several threaded blind holes on the surface shown, which surface is assembled in an outward direction relative to the motor housing, to make the blind tapped holes accessible from the outside of the motor housing.

In the embodiment of FIG. 6, a resolver cover is shown to the right of the rear end cap. The resolver cover has three through holes visible on the top surface thereof. The resolver cover is a cup shape, such as a right circular cylinder of revolution with one end closed. The resolver cover, when assembled to the rear end cap, defines a chamber within which a resolver is accommodated. In the embodiment shown, the resolver cover is attached with three screws. The resolver can be in contact with moisture.

In the embodiment of FIG. 6, there is also a shaft, comprising a substantially cylindrical piece having a plurality of different diameters defined along its length. As shown in FIG. 6, and looking from left to right, the shaft at its left end has a shaft end that protrudes from the front end cap; a surface that mates to the interior aperture of the left bearing through which the shaft passes when the left bearing is fitted to the front end cap; a diameter designed to mate with a permanent magnet rotor assembly and its protective stainless steel “can” components; a diameter designed to pass through the center aperture of the right bearing when the bearing is fitted into the rear end cap; and a diameter designed to mate with the rotating portion of a resolver that is accommodated within the volume defined by the resolver cover when mounted on the rear end cap.

Finally, in the embodiment of FIG. 6, there is shown a connector plate having defined therein two apertures. The larger aperture corresponds to aperture 1 of FIG. 1, and provides an aperture for the motor leads of the three phase motor to pass through. The smaller aperture corresponds to aperture 2 of FIG. 1, and provides an aperture for the resolver leads of the resolver to pass through. The two apertures are not required to have any particular relative size, and the sizes of the apertures have no significance for the invention. However, power leads generally are heavier gauge wire than signal leads, and often will require a larger aperture for their accommodation. As shown in the embodiment of FIG. 6, the apertures are threaded, to accommodate fitting that provide stress relief for the leads or other useful mechanical attributes. The connector plate is mounted to the motor housing in the substantially rectangular opening shown at the right side thereof, using screws. In the embodiment shown, four holes for mounting screws are defined within the connector plate, and the screws mate to blind tapped holes provided in the motor housing.

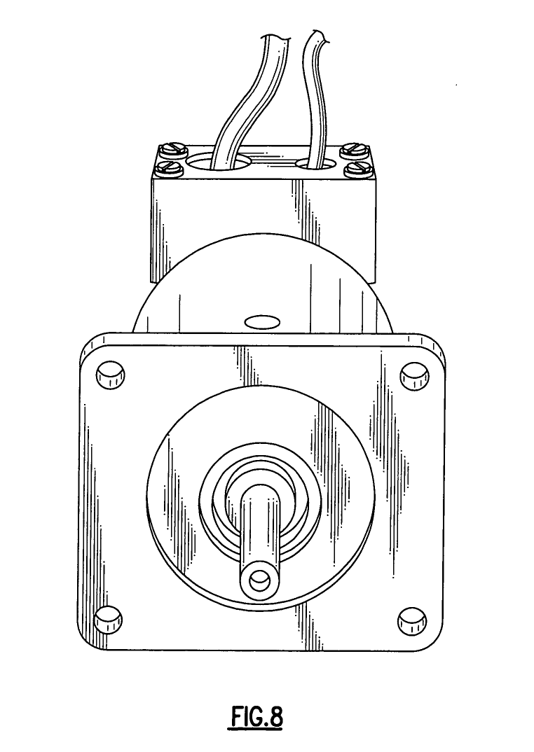

FIG. 7 is a depiction showing the disassembled electromagnetic components of a motor having a resolver. In the embodiment of FIG. 7, and looking from left to right, there are shown a stator for the permanent magnet motor; a resolver rotor and resolver stator; a shaft wherein the nearest end of the shaft corresponds to the left end of the shaft shown in FIG. 6; and a magnet and hub assembly comprising the permanent magnet rotor component of the motor. The shaft is shown in this embodiment with a fiduciary flat cut into the end of the shaft that is intended to protrude from the front end cap.

The stator shown in the embodiment of FIG. 7 is fitted within the motor housing shown in FIG. 6. The stator is a close fit to the internal diameter of the housing body. In one embodiment, the housing is shrunk over the stator to obtain an interference fit, thereby eliminating rotational or lateral movement. The stator is shown with motor leads attached thereto, which motor leads are cause to exit the motor housing through the aperture of the connector plate of FIG. 6.

The resolver rotor and resolver stator shown in the embodiment of FIG. 7 are assembled, respectively to the shaft and within the resolver cover shown in FIG. 6. The resolver stator is shown with leads protruding therefrom, which leads are passed through the resolver lead access opening in the rear end cap of FIG. 6 and through an aperture in the connector plate of FIG. 6. The resolver stator is secured to the rear end cap using servo cleats, thereby preventing the resolver stator from rotating or moving laterally.

FIG. 8 is a depiction of an assembled motor having a resolver. In the embodiment of FIG. 8, the front end cap is on the end of the assembled motor nearest the viewer, with the raised indexing surface visible. The shaft protrudes from the front end cap, and the fiduciary flat is visible at substantially the seven o'clock position. At the rear of the motor assembly, the connector plate is mounted to the motor housing. The motor leads pass through the connector plate in a substantially upward direction on the left, and the resolver leads pass through the connector plate in a substantially upward direction on the right. The cylindrical surface of the motor housing is visible between the front end cap and the connector plate. The resolver cap is present at the rear end of the assembly, but is not visible in the view shown.

FIG. 9 is a depiction of an embodiment of a stator and a resolver with conformal coating, according to principles of the invention. The conformal coating comprises parylene.

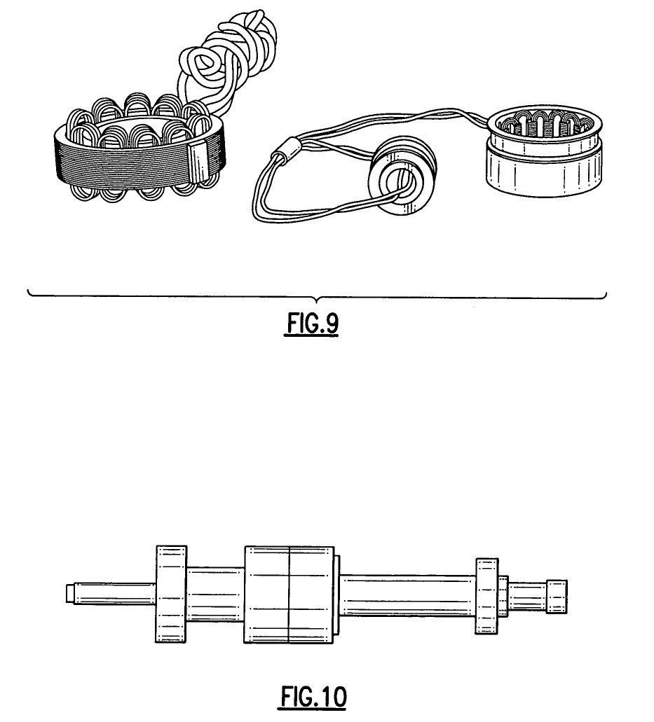

FIG. 10 is a depiction of an embodiment of a rotor with conformal coating, according to principles of the invention. The conformal coating comprises parylene. The rotor is shown mounted on the shaft (in the middle), and both the front bearing (at the left) and rear bearing (at the right) are mounted on the shaft as well.

We will now describe the operation of the motor and motor assembly according to principles of the invention. The operation of the motor and motor assembly is conducted in the conventional manner, for example in a mixing or stirring device. After the motor and motor assembly have completed the contemplated operation, such as mixing or stirring material for use in a food processing or medicinal processing operation subject to FDA regulation or oversight, the motor and motor assembly are removed, as necessary, from the food or medicine preparation apparatus. If the motor and motor assembly can be safely cleaned within the food or medicine preparation apparatus, the motor and motor assembly need not be removed, and optionally may be cleaned in place. The motor and motor assembly are washed down using a washing fluid, for example a water-based cleaning fluid. The washing fluid is permitted to enter the motor assembly during washing, and is permitted to exit the motor assembly upon completion of the washing process. The washing fluid can be drained from the motor assembly, for example by gravity, as part of the washing fluid removal process. Residual moisture that would otherwise remain within the motor assembly is removed (or driven off) by the heat generated by operating the motor. If necessary, the motor is operated for a time specifically to drive off moisture that may be present within the motor assembly or housing. The motor and motor assembly are reassembled in the food or medicine preparation apparatus, as necessary. Thus the motor and motor assembly are protected from corrosion during and after the washing process both by the fact that non-corroding materials of construction are used, and by the fact that the residual moisture can escape from the motor and motor assembly when the motor warms up, rather than remaining trapped in proximity to the motor windings for extended times when the motor is operated. Corrosion of the motor and motor assembly components is accordingly reduced, and premature failure of the motor is avoided.

While the present invention has been explained with reference to the structure disclosed herein, it is not confined to the details set forth and this invention is intended to cover any modifications and changes as may come within the scope of the following claims.

1. A washable electric motor assembly for use in food or medicine preparation applications subject to FDA oversight, comprising:
an electric motor having a component with a non-corroding exposed surface;
an unsealed housing comprising a non-corroding housing material, said unsealed housing configured to admit washing fluid during a washing operation and to allow the exit of the washing fluid upon completion of the washing operation;
whereby said washable electric motor assembly is resistant to the effects of corrosive substances, and said electric motor is protected against failure from corrosion by the exiting of the washing fluid from the unsealed housing.

2. The washable electric motor assembly according to claim 1, wherein the unsealed housing is further configured to permit the washing fluid to be driven off by thermal energy generated by operation of the electric motor.

3. The washable electric motor assembly according to claim 1, wherein a selected one of an electric motor having a component with a non-corroding exposed surface and a non-corroding housing material comprises titanium.

4. The washable electric motor assembly according to claim 1, wherein the non-corroding housing material comprises a base metal covered with a selected one of electroless nickel plating and cobalt coating.

5. The washable electric motor assembly according to claim 1, wherein the electric motor is a permanent magnet brushless motor.

6. The washable electric motor assembly according to claim 1, wherein a component of the motor comprises a coating of a vapor deposited material that can form a pinhole free protective film.

7. The washable electric motor assembly according to claim 6, wherein the vapor deposited material is parylene.

8. The washable electric motor assembly according to claim 1, further comprising an encoder.

9. The washable electric motor assembly according to claim 1, further comprising a resolver.

10. A method of washing an unsealed electric motor assembly, wherein the motor assembly includes an unsealed non-corroding housing material and a motor having non-corroding components, the motor assembly configured to be used in food or medicine preparation activities subject to FDA oversight, comprising the steps of:
washing the unsealed electric motor assembly with a washing fluid, whereby the washing fluid is permitted to enter the interior of the unsealed electric motor assembly;
removing the washing fluid from the unsealed electric motor assembly; and
operating the electric motor, whereby residual washing fluid remaining within the unsealed electric motor assembly is driven off as a result of the heating of the motor during said operation;
whereby said electric motor and said electric motor assembly are cleaned, and said electric motor is protected against failure from corrosion by the driving off of the residual fluid from the unsealed electric motor assembly.

11. The method of washing an unsealed washable electric motor assembly according to claim 10, wherein the step of removing the washing fluid from the unsealed washable electric motor assembly includes permitting the washing fluid to drain from the unsealed washable electric motor assembly.

12. The method of washing an unsealed electric motor assembly according to claim 10, further comprising the step of:
removing the unsealed electric motor assembly from an apparatus to which it is mounted prior to performing the washing step.
